(19) United States
(12) Patent Application Publication
(10) Pub. No.: US 2018/0329984 A1
(43) Pub. Date: Nov. 15, 2018

(54) METHODS AND SYSTEMS FOR DETERMINING AN EMOTIONAL CONDITION OF A USER

(71) Applicant: Gary S. Aviles, Charlotte, NC (US)

(72) Inventor: Gary S. Aviles, Charlotte, NC (US)

(21) Appl. No.: 15/977,932

(22) Filed: May 11, 2018

Related U.S. Application Data
(60) Provisional application No. 62/504,682, filed on May 11, 2017.

(51) Int. Cl. G06F 17/30; G06F 17/24; G06F 17/27; G06F 3/0482

(52) U.S. Cl. CPC G06F 17/30657; G06F 17/243; G06F 17/30557; G06F 3/0482; G06F 17/2735

(57) ABSTRACT

Disclosed is a method for determining an emotional condition of a user. The method includes transmitting, using a communication device, a questionnaire to the user, wherein the questionnaire includes one or more questions, wherein each question in the one or more questions includes one or more feeling descriptors. Further, the method includes receiving, using the communication device, a list of selected one or more feeling descriptors for each question in the one or more questions from the user. Yet further, the method includes storing, using a storage device, the list of selected one or more feeling descriptors for each question in the one or more questions. Moreover, the method includes generating, using a processing device, two sets of scores based on the list of selected one or more feeling descriptors for each question in the one or more questions to generate two sets of scores.

The current application claims a priority to the U.S. Provisional Patent application Ser. No. 62/504,682 filed on May 11, 2017.

### FIELD OF THE INVENTION

The present invention generally relates to the field of data processing. More specifically, the present disclosure relates to methods and systems to provide scores relating to the emotional condition of a user.

### BACKGROUND OF THE INVENTION

Emotional Intelligence may be defined as the capacity of an individual to be aware of, control, and express their emotions, and to handle interpersonal relationships judiciously and empathetically. In many cases, individuals struggle to find the words or descriptors that may define how they may feel at any particular moment. Moreover, individuals may not clearly understand how to mentally categorize the words and emotional descriptors to determine their emotional state. Lack of understanding of the emotional state may be a contributor to the diminished Emotional Intelligence of an individual.

Further, feelings and emotions are complex. Identifying the proper descriptor to express how an individual feel can be a challenge. Further, determining how to categorize the descriptor into an emotional state correctly may take time and practice. In addition, without guidance, there may not be a guarantee that an individual may correctly match one or more descriptors with an appropriate emotional state.

Further, a major challenge for many individuals seeking to increase their Emotional Intelligence is that the individuals may lack a rich vocabulary from which to select one or more feeling descriptors without prompts.

Accordingly, systems that may provide a reusable, random list of descriptors to an individual, so that the individual may be able to build a vocabulary of feelings, may not exist.

Further, systems that may measure a depth of immersion in an emotional state or Primary Emotion of an individual and provide an aggregate compilation score based on the measurements associated pre-determined emotions, such as bitter and sweet emotions, do not exist.

Therefore, there is a need for improved methods and systems to facilitate a user to determine a personal emotional state, and score and rank the emotional state against emotional parameters that may overcome one or more of the abovementioned problems and/or limitations.

### SUMMARY

This summary is provided to introduce a selection of concepts, in a simplified form, that are further described below in the Detailed Description. This summary is not intended to identify key features or essential features of the claimed subject matter. Nor is this summary intended to be used to limit the claimed subject matter's scope.

According to an aspect, a method for determining an emotional condition of a user is disclosed. The method may include transmitting, using a communication device, a questionnaire to the user, wherein the questionnaire includes one or more questions, wherein each question in the one or more questions includes one or more feeling descriptors. Further, the method may include receiving, using the communication device, a list of selected one or more feeling descriptors for each question in the one or more questions from the user. Further, the method may include storing, using a storage device, the list of selected one or more feeling descriptors for each question in the one or more questions. Further, the method may include generating, using a processing device, two sets of scores based on the list of selected one or more feeling descriptors for each question in the one or more questions to generate the two sets of scores.

According to another aspect, a system for determining an emotional condition of a user is disclosed. The system may include a communication device configured for transmitting a questionnaire to the user, wherein the questionnaire includes one or more questions, wherein each question in the one or more questions includes one or more feeling descriptors and receiving a list of selected one or more feeling descriptors for each question in the one or more questions from the user. Further, the system may include a storage device configured for storing the list of selected one or more feeling descriptors for each question in the one or more questions. Further, the system may include a processing device configured for generating two sets of scores based on the list of selected one or more feeling descriptors for each question in the one or more questions to generate two sets of scores.

According to some aspects, a method of facilitating a user to determine a personal emotional state, and score and rank the emotional state against emotional parameters is disclosed.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of a platform consistent with various embodiments of the present disclosure.

FIG. 2 is a block diagram of a system for determining an emotional condition of a user, in accordance with some embodiments.

FIG. 3 is a flowchart of a method for determining an emotional condition of a user, in accordance with some embodiments.

FIG. 4 illustrates a webpage containing a questionnaire in accordance with exemplary embodiments.

FIG. 5 illustrates a webpage containing test results, in accordance with exemplary embodiments.

FIG. 6 is a block diagram of a computing device for implementing the methods disclosed herein, in accordance with some embodiments.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of determining emotional states of users, in accordance with some embodiments, embodiments of the present disclosure are not limited to use only in this context.

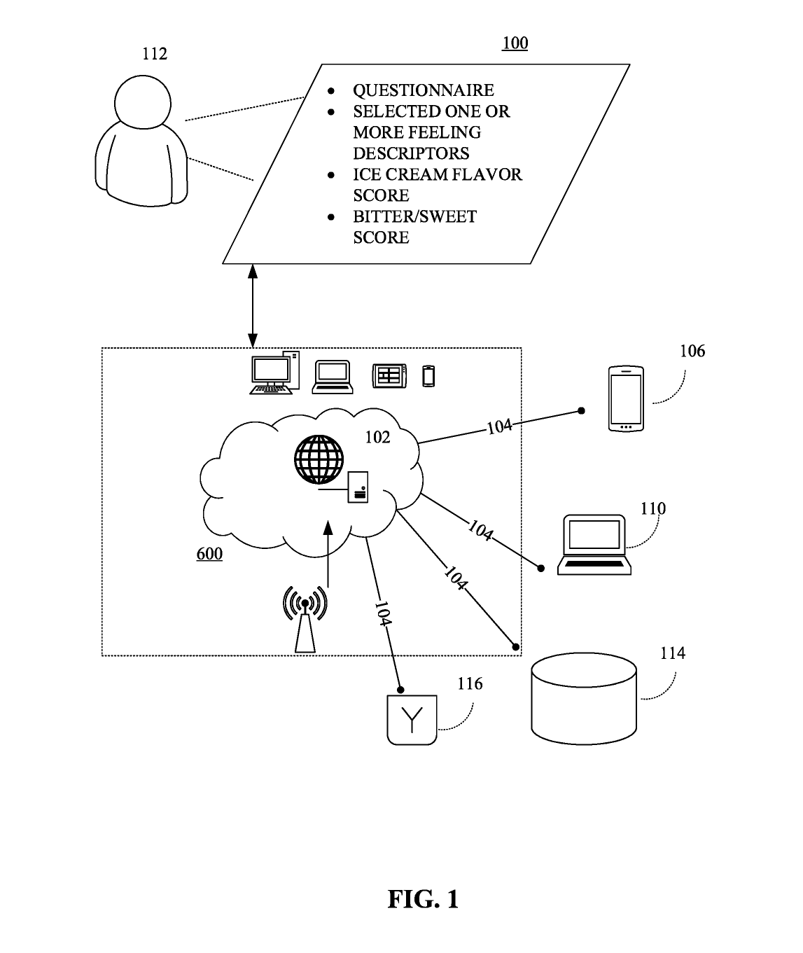

FIG. 1 is an illustration of a platform consistent with various embodiments of the present disclosure. By way of non-limiting example, the online platform 100 for determining an emotional condition of a user may be hosted on a centralized server 102, such as, for example, a cloud computing service. The centralized server 102 may communicate with other network entities, such as, for example, a mobile device 106 (such as a smartphone, a laptop, a tablet computer etc.), other electronic devices 110 (such as desktop computers, server computers etc.), and databases 114 (e.g. other online platforms) and sensors 116 (such as sensors to measure one or more of body temperature, heart rate, blood pressure, pulse, respiration rate etc.), over a communication network 104, such as, but not limited to, the Internet. Further, users of the platform may include relevant parties such as one or more of users, health care professionals, administrators, etc. Accordingly, electronic devices operated by the one or more relevant parties may be in communication with the online platform 100.

A user 112, such as the one or more relevant parties, may access online platform 100 through a web-based software application or internet browser. The web-based software application may be embodied as, for example, but not be limited to, a website, a web application, a desktop application, and a mobile application compatible with a computing device 600.

According to some embodiments, the online platform 100 may communicate with a system 200 for determining an emotional condition of a user.

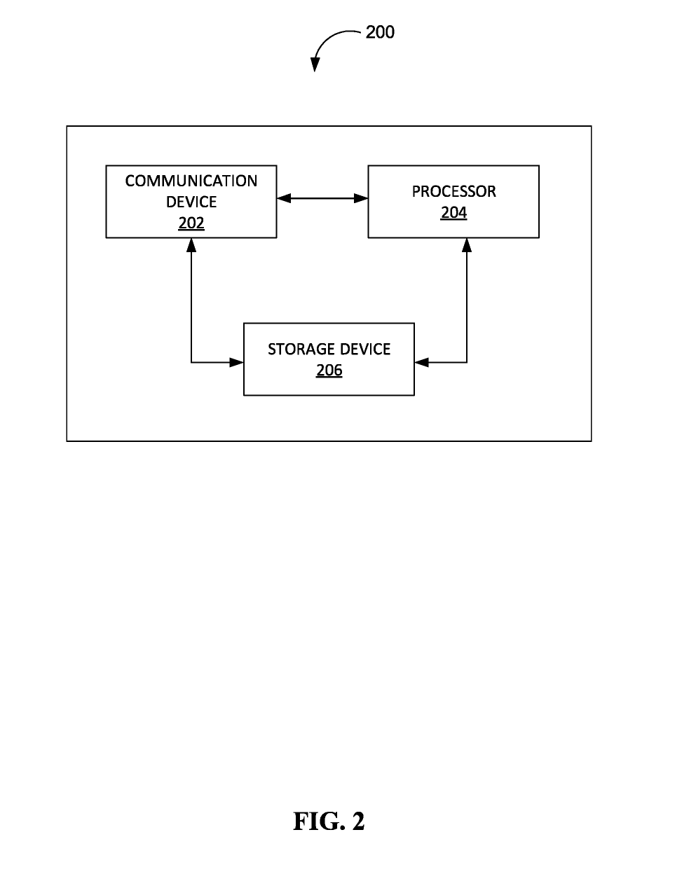

FIG. 2 is a block diagram of the system 200 for determining the emotional condition of the user, in accordance with some embodiments. The system 200 may include a communication device 202 configured for transmitting a questionnaire to the user. The questionnaire may include one or more questions. Further, each question in the one or more questions includes one or more feeling descriptors.

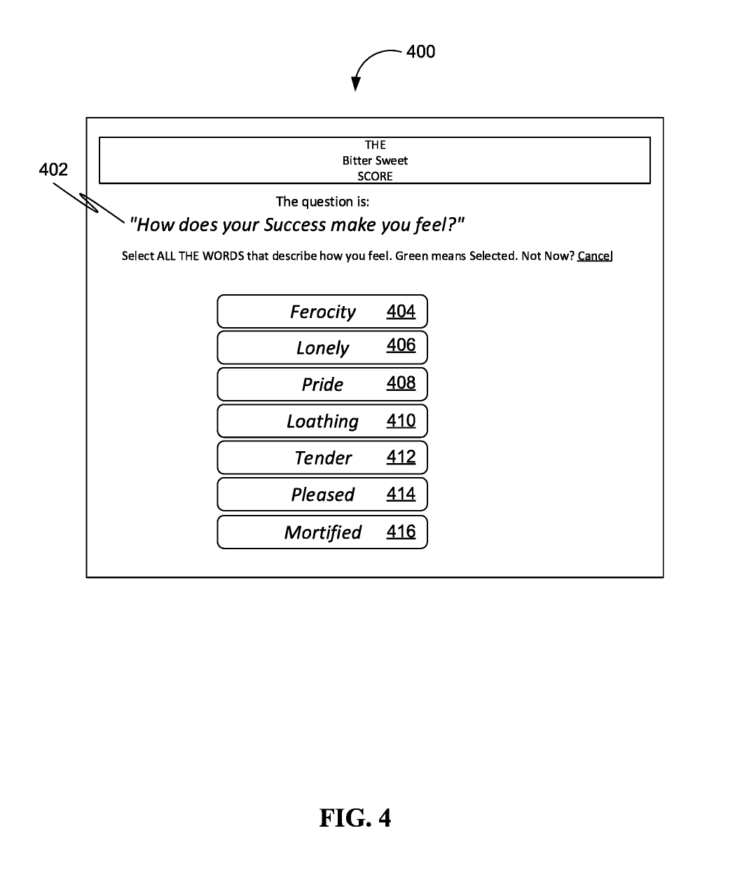

Further, the communication device 202 may be configured for receiving a list of selected one or more feeling descriptors for each question in the one or more questions from the user. For example, the questionnaire may be presented using a webpage as shown in FIG. 4 below. Accordingly, a user may answer a question in the questionnaire by selecting one or more feeling descriptors listed with the question on the webpage. This is explained in further detail in conjunction with FIG. 4 below.

Yet further, the system 200 may include a storage device 206 configured for storing the list of selected one or more feeling descriptors for each question in the one or more questions.

Further, the system 200 may include a processing device 204 configured for generating two sets of scores based on the list of selected one or more feeling descriptors for each question in the one or more questions to generate the two sets of scores.

In some embodiments, the system 200 may further include a first database comprising multiple questions and a second database comprising multiple feeling descriptors. The multiple questions included in the first database may be manually composed by an individual, and/or a psychologist or similar health care professionals to determine one or more feelings of a user based on the answers to the one or more questions. As such, the questions may not include right or wrong answers, and all answers to the one or more questions may describe a feeling of the user. Further, in an instance, the questions may be automatically scraped (using web scraping techniques) from online forums, blogs, articles, and so on. For instance, the questions may be automatically scraped from self-help articles, and motivational blogs related to emotional states of users. Accordingly, the self-help articles, motivational blogs, etc. may be analyzed, such as through Natural Language Processing (NLP), using the processing device 204, to scrape one or more questions in the multiple questions stored in the first database.

Further, the feeling descriptors included in the second database may be manually defined by a psychologist or similar health care professionals, so as to provide one or more individuals with a vocabulary to describe an emotional state of the one or more individuals. Further, the feeling descriptors may be automatically scraped from online forums, blogs, articles etc. For instance, the feeling descriptors may be automatically scraped from self-help articles, and motivational blogs related to emotional states of users. Accordingly, the self-help articles, motivational blogs, etc. may be analyzed, such as through Natural Language Processing (NLP), using the processing device 204, to scrape one or more feeling descriptors. Further, in an instance, the feeling descriptors may be automatically obtained from dictionaries, such as by analyzing, using the processing device 204, the dictionaries, and determining one or more words, the meaning of which may describe a feeling, such as sadness, joy, anxiety, etc.

Further, the processing device 204 may be configured to generate the questionnaire based on the first database and the second database.

Further, the system 200, using the processing device 204, may map the one or more feeling descriptors onto one or more emotional states. In an instance, the one or more emotional states may be related to, and described as one or more ice cream flavours. For instance, the emotional state of the user may include feeling love, surprise, joy, anger, fear, or sadness. Further, the emotional state of the user in one or more emotional states may be mapped onto one or more ice-cream flavors, such as chocolate, cookies and cream, vanilla, strawberry, chocolate chip and butter pecan. For instance, the emotional state of love may be mapped to strawberry flavored ice-cream.

Further, in an embodiment, each ice cream flavor in the one or more ice cream flavors may be categorized into one of a bitter category and a sweet category. The categorization may be based on an emotional state in the one or more emotional states related to the ice-cream flavor. For instance, emotions such as love, surprise, and joy, may be associated with ice-cream flavors, such as strawberry, butter pecan, and vanilla respectively. Further, emotions such as love, surprise, and joy, may be categorized as sweet. On the other hand, emotions such as anger, fear, and sadness, may be associated with ice cream flavors such as chocolate, chocolate chip, and cookies and cream respectively. Further, emotions such as anger, fear, and sadness may be categorized as bitter.

Further, each feeling descriptor in the one or more feeling descriptors may be categorized into one of a bitter category and a sweet category. For instance, feeling descriptors, such as pleased, tender, gay, and motivated may be described as sweet. On the other hand, feeling descriptors, such as mortified, loathing, and lonely may be described as bitter.

Further, the system 200, using the processing device 204, may calculate a first set of scores in the two sets of scores based on the one or more feeling descriptors, and the categorization of the one or more feeling descriptors. For instance, the first set of scores may measure a depth of immersion of the user in each emotional state. The first set of scores may be based on a calculation that may consider the number of feeling descriptors for a particular emotional state selected by the user against the total number of feeling descriptors available for selection for the same emotional state.

Further, the system 200, using the processing device 204, may calculate a second set of scores in the two sets of scores. The second set of scores may be related to an aggregate measurement related to the overall emotional condition of the user. For instance, the second set of scores may provide an aggregate compilation measurement based on the number of feeling descriptors, as chosen by the user, which may fall under the categorization of bitter or sweet. In an instance, the second set of scores may be called as the BitterSweet score.

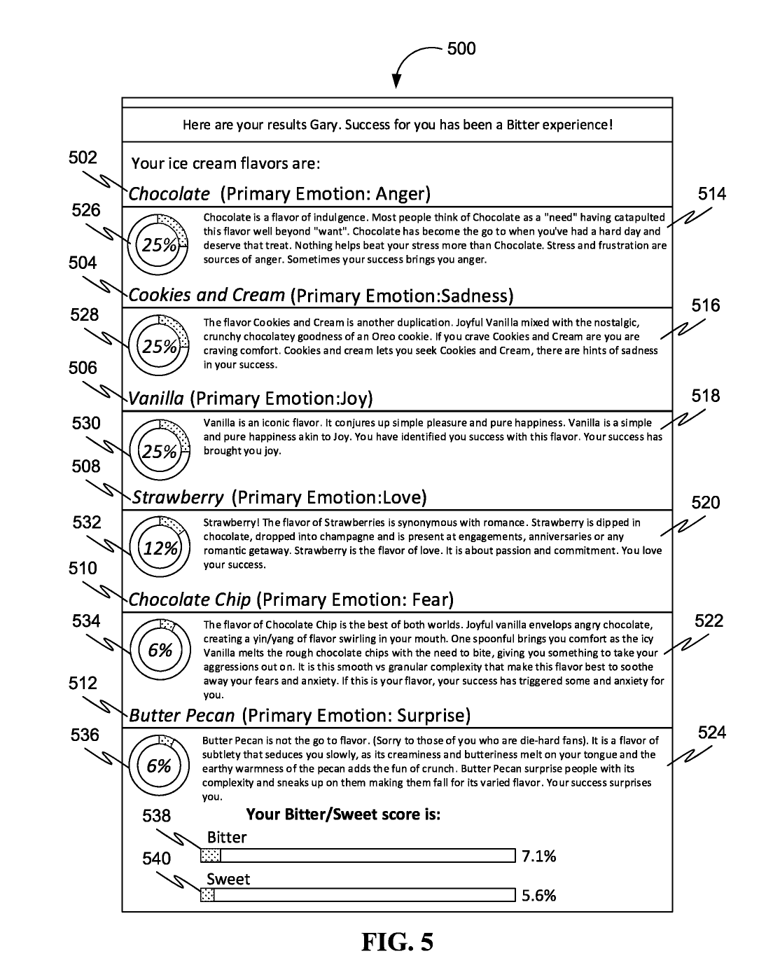

Further, in an embodiment, the system 200 may include a display device configured to display the two sets of scores to the user. For example, the display device may be a display of a user device, such as a smartphone. For example, the two sets of scores may be shown on a webpage as shown in FIG. 5. This is explained in further detail in conjunction with FIG. 5 below.

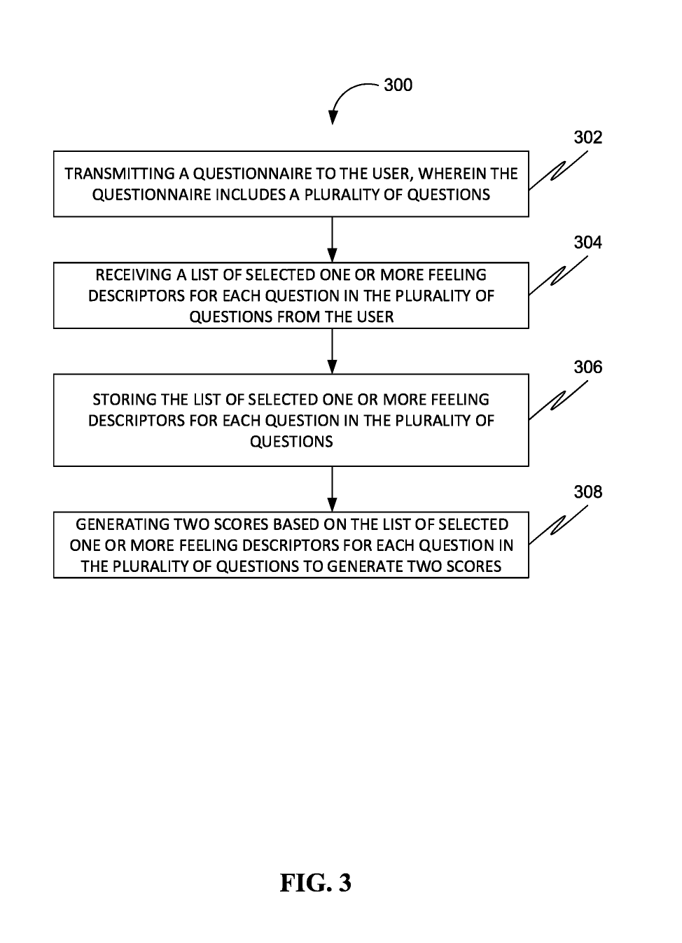

FIG. 3 is a flowchart of a method 300 for determining an emotional condition of a user, in accordance with some embodiments. At 302, the method may include transmitting, using a communication device, a questionnaire to the user The questionnaire may include one or more questions. Further, each question in the one or more questions may include one or more feeling descriptors as answer options. Further, the questionnaire may be generated based on a first database comprising multiple questions and a second database comprising multiple feeling descriptors. The questions included in the first database may be manually composed by an individual user, a psychologist or similar health care professionals to determine one or more feelings of a user based on the answers of the one or more questions. As such, the questions may not include right or wrong answers, and all answers to the one or more questions may describe a feeling of the user. Further, in an instance, the questions may be automatically scraped from online forums, blogs, articles, and so on. For instance, the questions may be automatically scraped from self-help articles, motivational blogs etc., which may include the one or more questions to allow one or more readers of the self-help articles, motivational blogs etc. to determine an emotional state. Further, the feeling descriptors included in the second database may be manually defined by a psychologist or similar health care professionals, so as to provide one or more individuals with a vocabulary to describe an emotional state of the one or more individuals. Further, the feeling descriptors may be automatically scraped from online forums, blogs, and articles. For instance, the feeling descriptors may be automatically scraped from self-help articles, motivational blogs etc. Accordingly, the self-help articles, motivational blogs, etc. may be analyzed, such as through NLP to scrape one or more feeling descriptors. Further, in an instance, the feeling descriptors may be automatically obtained from dictionaries, such as by analyzing the dictionaries, and determining one or more words, the meaning of which may describe a feeling, such as sadness, joy, anxiety etc.

At 304, the method may include receiving, using the communication device, a list of selected one or more feeling descriptors for each question in the one or more questions from the user. For example, the questionnaire may be presented using a webpage as shown in FIG. 4 below. Accordingly, a user may answer a question in the questionnaire by selecting one or more feeling descriptors listed with the question on the webpage. This is explained in further detail in conjunction with FIG. 4 below.

At 306, the method may include storing, using a storage device, the list of selected one or more feeling descriptors for each question in the one or more questions.

At 308, the method may include generating, using a processing device, two sets of scores based on the list of selected one or more feeling descriptors for each question in the one or more questions to generate the two sets of scores.

Further, the one or more feeling descriptors may be mapped onto one or more emotional states. In an instance, the one or more emotional states may be related to, and described as one or more ice cream flavours. For instance, the emotional state of the user may include feeling love, surprise, joy, anger, fear, or sadness. Further, the emotional state of the user in one or more emotional states may be mapped onto one or more ice-cream flavors. For instance, the emotional state of love may be mapped to strawberry flavored ice-cream.

Further, in an embodiment, each ice cream flavor in the one or more ice cream flavors may be categorized into one of a bitter category and a sweet category. The categorization may be based on an emotional state in the one or more emotional states related to the ice-cream flavor. For instance, emotions such as love, surprise, and joy may be associated with ice-cream flavors, such as strawberry, butter pecan, and vanilla, respectively. Further, emotions such as love, surprise, and joy may be categorized as sweet. However, the emotions such as anger, fear, and surprise may be associated with ice cream flavors such as chocolate, chocolate chip, and cookies and cream, respectively. Further, the emotions such as anger, fear, and sadness may be categorized as bitter.

Further, each feeling descriptor in the one or more feeling descriptors may be categorized into one of a bitter category and a sweet category. For instance, feeling descriptors, such as pleased, tender, gay, and motivated may be associated as sweet. However, the feeling descriptors, such as mortified, loathing, lonely, and so on may be described as bitter.

Further, a first set of scores in the two sets of scores may be calculated based on the one or more feeling descriptors, and the categorization of the one or more feeling descriptors. For instance, the first set of scores may measure a depth of immersion of the user in each emotional state and may be based on a calculation that may consider the number of feeling descriptors for a particular emotional state selected by the user against the total number of feeling descriptors available for selection for the same emotional state.

Further, a second set of scores in the two sets of scores may be calculated. The second set of scores may be related to an aggregate measurement related to the overall emotional condition of the user. For instance, the second set of scores may provide an aggregate compilation measurement based on the number of feeling descriptors, as chosen by the user, which may fall under the categorization of bitter or sweet. In an instance, the second set of scores may be called as the BitterSweet score.

Further, in an embodiment, the two sets of scores may be displayed to the user using a display device, such as the display of a user device such as a smartphone. For example, the two sets of scores may be shown on a webpage as shown in FIG. 5. This is explained in further detail in conjunction with FIG. 5 below.

FIG. 4 illustrates a webpage 400 containing a questionnaire in accordance with exemplary embodiments. The questionnaire may include one or more questions, such as the question 402 asking a user to describe how the success of the user may make the user feel. The question 402 may further include one or more feeling descriptors that may be selected by the user as an answer to the one or more questions. Accordingly, the webpage 400 includes buttons 404-416 for the multiple feeling descriptors, namely ferocity, lonely, pride, loathing, tender, pleased, and mortified respectively. The user may select one or more feeling descriptors by pressing the one or more buttons in response to the question 402. Further, in an embodiment, when the user hovers a cursor or a mouse pointer over any of the one or more buttons, an additional pop-up may appear. The additional pop-up may display a definition of the feeling descriptor, that may allow the user to completely understand the meaning of feeling descriptor and choose one or more of the feeling descriptors appropriately.

FIG. 5 illustrates a webpage 500 containing test results, in accordance with exemplary embodiments. The test results may be generated based on the responses of one or more questions, such as the question 402, received in the form of one or more feeling descriptors, such as through the one or more buttons 404-416.

As shown in FIG. 5, the first set of scores may be displayed as a percentage of immersion in emotional states. In an instance, the one or more emotional states may be related to, and described as one or more ice cream flavours ice cream flavors. Therefore, immersion in anger may be represented by chocolate 502, and may be calculated to be 25% (526). Further, immersion in sadness may be represented by cookies and cream 504 and may be calculated to be 25% (528). Further, immersion in joy may be represented by vanilla 506 and may be calculated to be 25% (530). Further, immersion in love may be represented by strawberry 508 and may be calculated to be 16% (532). Further, immersion in fear may be represented by chocolate chip 510 and may be calculated to be 6% (534). Further, immersion in surprise may be represented by butter pecan 512 and may be calculated to be 6% (536). Further, the descriptions 514-524 of the ice cream flavors 502-512 may be displayed for the user.

Further, a second set of scores (the BitterSweet score) may be calculated and displayed. As described above, the second set of scores is related to an aggregate measurement related to the emotional condition of the user. For instance, the second set of scores may provide an aggregate compilation measurement based on the number of feeling descriptors, as chosen by the user, which may fall under the categorization of bitter or sweet as a percentage. As shown in FIG. 5, the second set of scores may be displayed as a graph, such as graphs displaying a Bitter score 538 as 7.1%, and a Sweet score 540 5.6%.

Further, in an additional embodiment, the BitterSweet score of the user may be tracked over a period of time, along with the one or more parameters, such as the feeling descriptors, and the emotional states of the user. As such, based on the change in the BitterSweet score, the change in the emotional health of the user and the emotional quotient of the user may be detected. For instance, if the BitterSweet score of the user increases in the sweet category and/or reduces in the bitter category, the emotional health of the user may be determined to be improving. Further, if an increase in the number of feeling descriptors used by the user to describe the emotional state is observed, the emotional quotient of the user (the ability of the user to describe one or more feelings that the user may possess) may be determined to be increasing.

According to an exemplary embodiment, a percentage of the feeling descriptors selected by the user for the one or more primary emotional states, amongst the total feeling descriptors for the one or more described primary emotional states may be calculated and displayed as the first set of scores (the depth of immersion in an emotional state). Accordingly, the number of feeling descriptors available for the one or more primary emotional states as described by the user through the one or more selected feeling descriptors may be taken as a base.

Therefore, the first set of scores may be calculated by using the mathematical formula for percentage, that may be represented by equation 1 below.

P(I)ₑₘₒₜᵢₒₙ=[n(I)ₑₘₒₜᵢₒₙ*100]/n(T)ₑₘₒₜᵢₒₙ (1)

where, P(I)ₑₘₒₜᵢₒₙ represents the depth of immersion in an emotional state as a percentage,

n(I)ₑₘₒₜᵢₒₙ represents the number of feeling indicators, as chosen by the user, corresponding to the emotional state, and

n(T)ₑₘₒₜᵢₒₙ represents the total number of feeling indicators corresponding to the emotional state.

For instance, as shown in FIG. 4, the user may select the feeling descriptors ferocity 404 and mortified 416, which may relate to the emotional states anger and fear, respectively. Further, the total number of feeling descriptors corresponding to anger and fear may be ten each. Therefore, by substituting the values of n(I)ₑₘₒₜᵢₒₙ and n(T)ₑₘₒₜᵢₒₙ as one and 10 in the equation 1 for anger, the values of P(I)ₑₘₒₜᵢₒₙ for anger may be calculated as 10%. Similarly, by substituting the values of n(I)ₑₘₒₜᵢₒₙ and n(T)ₑₘₒₜᵢₒₙ as one and 10 in the equation 1 for fear, the values of P(I)ₑₘₒₜᵢₒₙ for fear may be calculated as 10%.

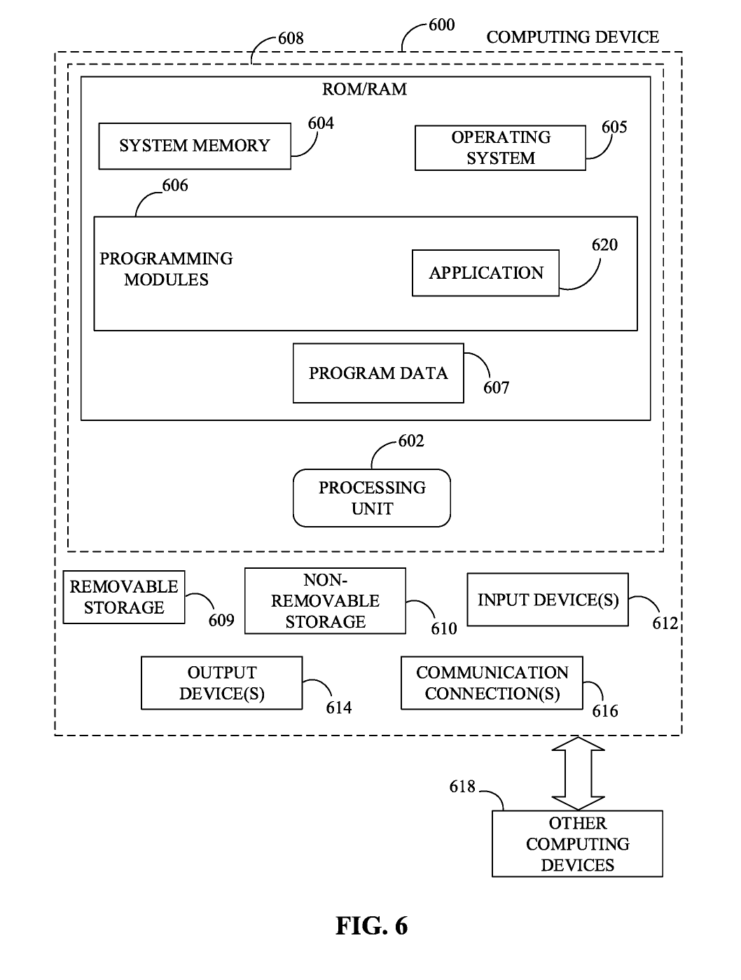

FIG. 6 is a block diagram of a computing device for implementing the methods disclosed herein, in accordance with some embodiments. Consistent with an embodiment of the disclosure, the aforementioned storage device and processing device may be implemented in a computing device, such as computing device 600 of FIG. 6. Any suitable combination of hardware, software, or firmware may be used to implement the memory storage and processing unit. For example, the storage device and the processing device may be implemented with computing device 600 or any of other computing devices 618, in combination with computing device 600. The aforementioned system, device, and processors are examples and other systems, devices, and processors may comprise the aforementioned storage device and processing device, consistent with embodiments of the disclosure.

With reference to FIG. 6, a system consistent with an embodiment of the disclosure may include a computing device or cloud service, such as computing device 600. In a basic configuration, computing device 600 may include at least one processing unit 602 and a system memory 604. Depending on the configuration and type of computing device, system memory 604 may comprise, but is not limited to, volatile (e.g. random-access memory (RAM)), non-volatile (e.g. read-only memory (ROM)), flash memory, or any combination. System memory 604 may include operating system 605, one or more programming modules 606, and may include a program data 607. Operating system 605, for example, may be suitable for controlling computing device 600's operation. Furthermore, embodiments of the disclosure may be practiced in conjunction with a graphics library, other operating systems, or any other application program and is not limited to any particular application or system. This basic configuration is illustrated in FIG. 6 by those components within a dashed line 608.

Computing device 600 may have additional features or functionality. For example, computing device 600 may also include additional data storage devices (removable and/or non-removable) such as, for example, magnetic disks, optical disks, or tape. Such additional storage is illustrated in FIG. 6 by a removable storage 609 and a non-removable storage 610. Computer storage media may include volatile and nonvolatile, removable and non-removable media implemented in any method or technology for storage of information, such as computer-readable instructions, data structures, program modules, or other data. System memory 604, removable storage 609, and non-removable storage 610 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 600. Any such computer storage media may be part of device 600. Computing device 600 may also have input device(s) 612 such as a keyboard, a mouse, a pen, a sound input device, a touch input device, etc. Output device(s) 614 such as a display, speakers, a printer, etc. may also be included. The aforementioned devices are examples and others may be used.

Computing device 600 may also contain a communication connection 616 that may allow device 600 to communicate with other computing devices 618, such as over a network in a distributed computing environment, for example, an intranet or the Internet. Communication connection 616 is one example of communication media.

Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 604, including operating system 605. While executing on processing unit 602, programming modules 606 (e.g., application 620) may perform processes including, for example, one or more stages of methods 300, algorithms, systems, applications, servers, databases as described above. The aforementioned process is an example, and processing unit 602 may perform other processes. Other programming modules that may be used in accordance with embodiments of the present disclosure may include sound encoding/decoding applications, machine learning application, acoustic classifiers etc.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, multiprocessor systems, microprocessor-based or programmable consumer electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

What is claimed is:

1. A method for determining an emotional condition of a user, the method comprising:
transmitting, using a communication device, a questionnaire to the user, wherein the questionnaire includes one or more questions, wherein each question in the one or more questions includes one or more feeling descriptors;
receiving, using the communication device, a list of selected one or more feeling descriptors for each question in the one or more questions from the user;
storing, using a storage device, the list of selected one or more feeling descriptors for each question in the one or more questions; and
generating, using a processing device, two sets of scores based on the list of selected one or more feeling descriptors for each question in the one or more questions to generate two sets of scores.

2. The method of claim 1 further includes generating the questionnaire based on a first database comprising a plurality of questions and a second database comprising a plurality of feeling descriptors.

3. The method of claim 1, wherein the one or more feeling descriptors are mapped onto one or more ice emotional states.

4. The method of claim 3, wherein each emotional state in the one or more emotional states is categorized into one of a bitter category and a sweet category.

5. The method of claim 1, wherein each feeling descriptor in the one or more feeling descriptors is categorized into one of a bitter category and a sweet category.

6. The method of claim 1, wherein a first set of scores in the two sets of scores is related to a depth of immersion of the user in each emotional state in one or more emotional states.

7. The method of claim 1, wherein a second set of scores in the two sets of scores is related to an aggregate measurement related to the emotional condition of the user.

8. The method of claim 1 further includes displaying, using a display device, the two sets of scores to the user.

9. The method of claim 1 wherein generating the two sets of scores further includes processing, using the processing device, the one or more measurements.

10. The method of claim 1 further including tracking at least one set of score in the two sets of scores over a period of time.

11. A system for determining an emotional condition of a user, the system comprising:
a communication device configured to:
transmit a questionnaire to the user, wherein the questionnaire includes one or more questions, wherein each question in the one or more questions includes one or more feeling descriptors;
receive a list of selected one or more feeling descriptors for each question in the one or more questions from the user;
a storage device configured to store the list of selected one or more feeling descriptors for each question in the one or more questions; and
a processing device configured to generate two sets of scores based on the list of selected one or more feeling descriptors for each question in the one or more questions to generate two sets of scores.

12. The system of claim 11 further includes a first database comprising a plurality of questions and a second database comprising a plurality of feeling descriptors, wherein the processing device is configured to generate the questionnaire based on the first database and the second database.

13. The system of claim 11, wherein the one or more feeling descriptors are mapped onto one or more emotional states.

14. The system of claim 13, wherein each emotional state in the one or more emotional states is categorized into one of a bitter category and a sweet category.

15. The system of claim 11, wherein each feeling descriptor in the one or more feeling descriptors is categorized into one of a bitter category and a sweet category.

16. The system of claim 11, wherein a first set of scores in the two sets of scores is related to a depth of immersion of the user in each emotional state in one or more emotional states.

17. The system of claim 11, wherein a second set of score in the two sets of scores is related to an aggregate measurement related to the emotional condition of the user.

18. The system of claim 11 further includes a display device configured to display the two sets of scores to the user.

19. The system of claim 11 wherein the processing device is further configured to process the one or more measurements to the generate the two sets of scores.

20. The system of claim 11 wherein the processing device is further configured to track at least one set of score in the two sets of scores over a period of time.
